(19) United States
(12) Patent Application Publication
(10) Pub. No.: US 2004/0205617 A1
(43) Pub. Date: Oct. 14, 2004

(54) Custom report generation using XML and XSL

(75) Inventor: Claude W. Light, Alpharetta, GA (US)

Correspondence Address: PAUL W. MARTIN, LAW DEPARTMENT, WHQ-4, 1700 S. PATTERSON BLVD., DAYTON, OH, 45479-0001, US

(73) Assignee: NCR Corporation

(21) Appl. No.: 09/985,840

(22) Filed: Nov. 6, 2001

(51) Int. Cl. G06F 17/00

(52) U.S. Cl. 715/523; 715/513

(57) ABSTRACT

A method of generating a report using XML and XSL is described. A user browses to a web site and obtains XML-based report content to be formatted. The XML-based report content is received and processed. An HTML-based format report is generated by applying an XSL-based format to the XML-based report content.

### FIELD OF THE INVENTION

The present invention relates generally to report generation, and more particularly, to report generation using extensible markup language (XML) and extensible style sheet language (XSL). Further, the present invention also relates to web-based report generation.

### BACKGROUND ART

Report generation is an integral part of all business operations and the increasing popularity of the internet means that access to these reports is no longer limited to the back office. Managers can now access business reports from anywhere in the world. In order to provide this access, web sites have been developed to (a) retrieve accumulated business data, (b) generate report content by performing calculations on the data, and (c) generate reports formatted in a way meaningful to the user. The result is a custom hypertext markup language (HTML) report providing insight into business operations such as financial performance, inventory status, and labor scheduling.

A block diagram of a typical web-based reporting scenario is shown in FIG. 1. Business data stored in database 10 is accessed by a web site 12 which is in turn accessed by a web browser 14 used by a user (not shown). The user, typically a manager, browses using web browser 14 to web site 12, typically an internal business-related web site or restricted access web site, to view business reports. The business reports are HTML-formatted reports, such as report 16. Report 16 is generated by web site 12 using a content and format generation module 18 to select and format the data obtained from database 10. FIG. 2 is an example report 16 obtained by a user from web site 12 presenting data from database 10.

A major problem with the above-described implementation is a lack of a flexible report format. Because the report content and format are created and combined together by the web site, the web site author can only provide a limited number of formats to users. Additional formats can be added to the web site, but this can be expensive. Since the web site has combined content generation and format generation, changes in the format can cause undesirable changes in the content for different users or purposes. As a consequence, a cosmetic change in the format can be difficult to make and will require expensive regression testing to insure that the content has not been compromised. Furthermore, changes to a web site to accommodate one user can cause interruptions to others users. For example, a desired change to a report for one user may not be desired by other users.

A method is needed for providing web-based reports that provide users the ability to modify the report format without modifying the report web site, interrupting other users, or modifying other users report formats.

### DISCLOSURE/SUMMARY OF THE INVENTION

It is therefore an object of the present invention to provide a web-based reporting method providing users with the ability to modify report formats without modifying a report web site.

Another object of the present invention is to provide a web-based reporting method providing users with the ability to modify report formats without interrupting other users.

Another object of the present invention is to provide a web-based reporting method providing users with the ability to modify report formats without modifying other users report formats.

The above described objects are fulfilled by a method of generating a report using XML and XSL. A user has a web browser and an XSL-based report format. The user browses to a web site and obtains XML-based report content to be formatted. The XML-based report content is received and processed and generates an HTML-based format report by applying an XSL-based format to the XML-based report content. Advantageously, the user is not restricted in the formatting options available for viewing the report content. The user may generate and apply their own formatting to the report content without interrupting other users report formats.

In an apparatus aspect, a computer system for generating a web-based report using a markup language and a stylesheet language includes a processor for receiving and transmitting data and a memory coupled to the processor. The memory stores a stylesheet language report format and sequences of instructions. When the sequences of instructions are executed by the processor, the processor receives report content in a markup language format, and generates a markup language format report by applying a stylesheet language format to the received report content.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a block diagram of a prior art method of web-based report generation;

FIG. 2 is an example report generated by the prior art method of FIG. 1;

FIG. 3 is a high level block diagram of an embodiment of the present invention;

FIG. 4 is an example report generated by the embodiment of FIG. 3;

FIG. 5 is another example report generated by the embodiment of FIG. 3;

FIG. 6 is another example report generated by the embodiment of FIG. 3; and

FIG. 7 is a high level block diagram of a computer system usable with the present invention.

### BEST MODE FOR CARRYING OUT THE INVENTION

A method and apparatus for generating a report using XML and XSL are described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

### Detailed Description

The present invention provides a method for creating web based reports by providing users the ability to modify the report format without modifying the report web site or interrupting other users. The invention improves upon existing web-based reporting mechanisms by using XML and XSL technologies to separate report content from report format. Specifically, instead of coupling report content and format into an HTML document at the web site, report content is transmitted from the web site to the web browser in an XML format. The presentation format of the report is defined in an XSL file which is applied to the XML report content to create the final HTML report.

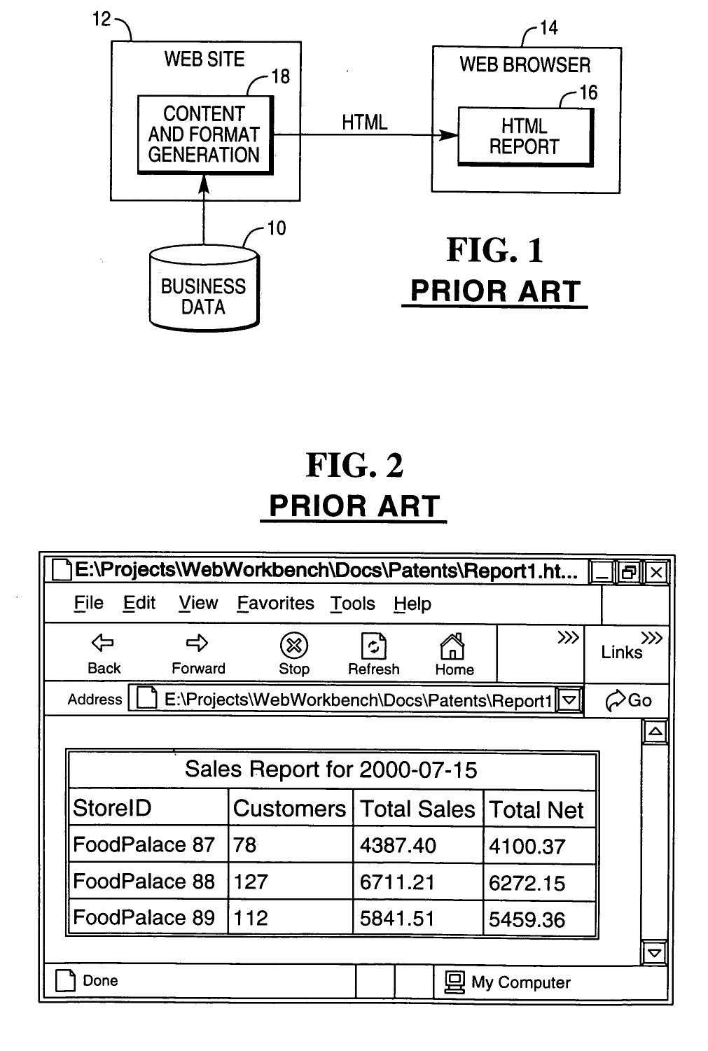

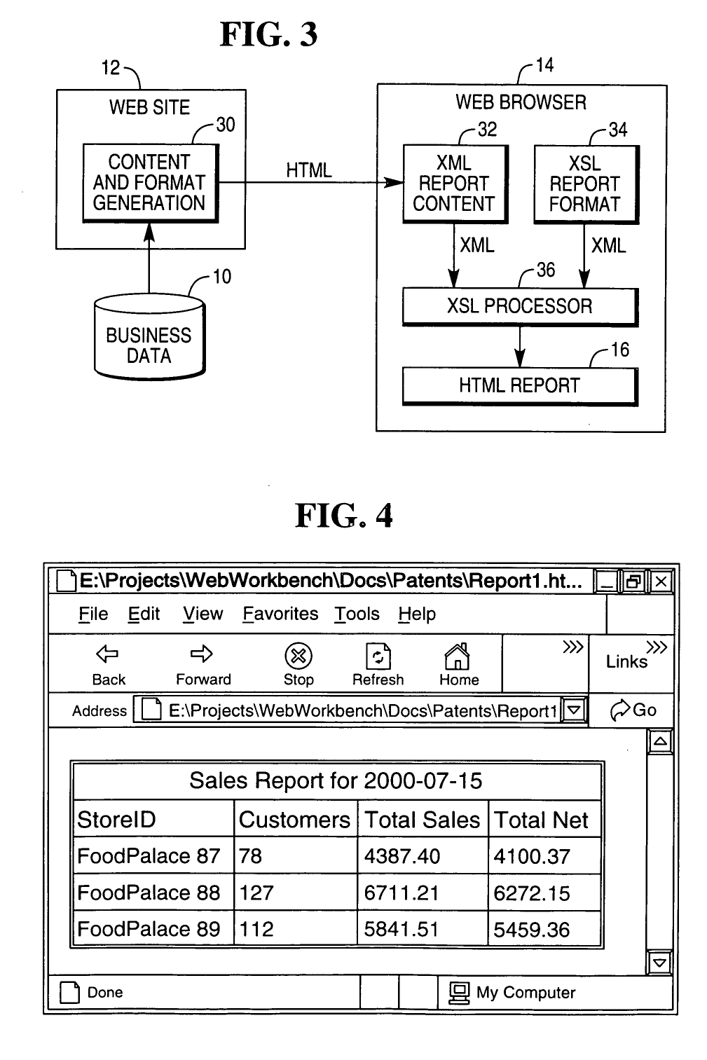

The diagram in FIG. 3 illustrates an embodiment of the present invention. Similar to the embodiment of FIG. 1, FIG. 3 includes a database 10 storing data, a web site 12, and a web browser 14 usable by a user (not shown). The similarity ends there as, in contrast, the web site 12 of FIG. 3 includes a content generation module 30 for obtaining and generating report content from the data from database 10. The format generation functionality of content and format generation module 18 (FIG. 1) is not included in web site 12. The web browser 14 includes not only the generated HTML report 16, but also XML report content module 32 for receiving the content from web site 12, XSL report format 34 specifying the format of the report to be generated, and XSL processor 36 for generating the HTML report 16 from XML report content module 32 as specified by XSL report format 34.

The XSL processor 36 is executable software using XSL, a technology for transforming one XML document or data into another XML document format. XSL documents use XML format such that all XSL documents are also XML documents. The information contained in an XSL document provides instructions that an XSL processor 36 uses to perform the XML document transformation. The XSL transformation language is defined by the World Wide Web Consortium (W3C) standards body available at http://www.w3.org. The examples provided in this disclosure were created using an XSL processor available from Microsoft, although the disclosure is applicable to any XSL processor.

In this manner, different users may have different XSL report formats 34 to be applied to the report content obtained from web site 12. Because the formatting is separate from the content, formatting changes made by one user need not impact any other user's report format.

XML is a syntax for storing information in a human readable form using human readable tags that define the meaning of the information. For example, a sales report in XML format is shown in Listing 1.

### Listing 1

<?xml version= “1.0”?>
<SalesReport Date= “2000-07-15”>

<Store>

<StoreID>Food Palace 87</StoreID>
<TotalCustomers>78 </Total Customers>
<TotalSales>4387.40</TotalSales>
<TotalNet>4100.37 </Total Net>

</Store>
<Store>

<StoreID>Food Palace 88</StoreID>
<TotalCustomers>127</Total Customers>
<TotalSales>6711.21</TotalSales>
<TotalNet>6272.15</TotalNet>

</Store>
<Store>

<StoreID>Food Palace 89</StoreID>
<TotalCustomers> 112 </TotalCustomers>
<TotalSales>5841.5 </TotalSales>
<TotalNet> 5459.36 </TotalNet>

</Store>

</SalesReport>

All of the report content is identified by tags, i.e., text placed between brackets, e.g., <StoreID>, <TotalCustomers>, and <TotalSales>. The data of the report follows the tag identifying it. That is, “FoodPalace 87” is the store identifier specified by the <StoreID> tag, “78” is the total number of customers (<TotalCustomers> tag) at the store having a <StoreID> of “Food Palace 87”. The rest of the data of the report is similarly specified. <TotalSales> is “4387.40 and <TotalNet> is “4100.37” for “FoodPalace 87”.

XSL uses XML syntax to define information that is used to transform one XML document into another. For example, an XSL file for transforming the Listing 1 XML report into another XML document using HTML tags is shown in Listing 2.

### Listing 2

<?xml version=“1.0” ?>
<xsl:stylesheet xmlns:xsl=“http://www.w3.org/TR/WD-xsl”>

<xsl:template>

<xsl:apply-templates />

</xsl:template>
<xsl:template match=“/”>

<HTML>
<BODY>
<xsl: apply-tem plates select= “SalesReport” />
</BODY>
</HTML>

</xsl:template>
<xsl:template match= “Sales Report”>

<TABLE cellspacing=“1” border=“1”>
<TR>
<TD ColSpan=“100%” Align= “Center” Style=“font-weight:bold”>
Sales Report for <xsl:value-ofselect= “@Date”/>
</TD>
</TR>
<TR>
<TD Style= “font-weight:bold”>StoreID </TD>
<TD Style= “font-weight:bold”> Customers</TD>
<TD Style= “font-weight:bold”>Total Sales</TD>
<TD Style= “font-weight:bold”>Total Net</TD>
</TR>
<xsl:for-each select= “Store”>
<TR>
<TD><xsl:value-of select= “StoreID”/> </TD>
<TD><xsl:value-of select= “TotalCustomers”/> </TD>
<TD><xsl:value-of select= “TotalSales”/> </TD>
<TD><xsl:value-of select= “TotalNet”/> </TD>
</TR>
</xsl:for-each>
</TABLE>

</xsl:template>

</xsl:stylesheet>

The result of the transformation would be the XML compliant HTML document shown in Listing 3. This document could then be viewed using a web browser 14. FIG. 4 shows how the Listing 3 document would be rendered in a web browser.

### Listing 3

<HTML>

<BODY>

<TABLE cellspacing=“1” border=“1”>
<TR>

<TD ColSpan= 100%“ Align= “Center” Style=“font-weight:bold”>
Sales Report for 2000-07-15
</TD>

</TR>
<TR>

<TD Style= “font-weight :bold” >StoreID</TD>
<TD Style= “font-weight: bold” >Customers</TD>
<TD Style= “font-weight: bold” >Total Sales</TD>
<TD Style= “font-weight: bold” >Total Net</TD>

</TR>
<TR>

<TD>FoodPalace 87</TD>
<TD>78</TD>
<TD>4387.40</TD>
<TD>4100.37</TD>

</TR>
<TR>

<TD>FoodPalace 88</TD>
<TD>127</TD>
<TD>6711.21</TD>
<TD>6272.15</TD>

</TR>
<TR>

<TD>FoodPalace 89</TD>
<TD>112</TD>
<TD>5841.51</TD>
<TD>5459.36</TD>

</TR>
</TABLE>

</BODY>

</HTML>

By separating report content from report format, a single report can be rendered in an infinite number of formats without modifying the report web site. For example, a user may only be interested in one field of a complex sales report and another user may want to show all fields, but alter the order, header, and colors. This can easily be accomplished by creating a custom XSL formatting definition for each user.

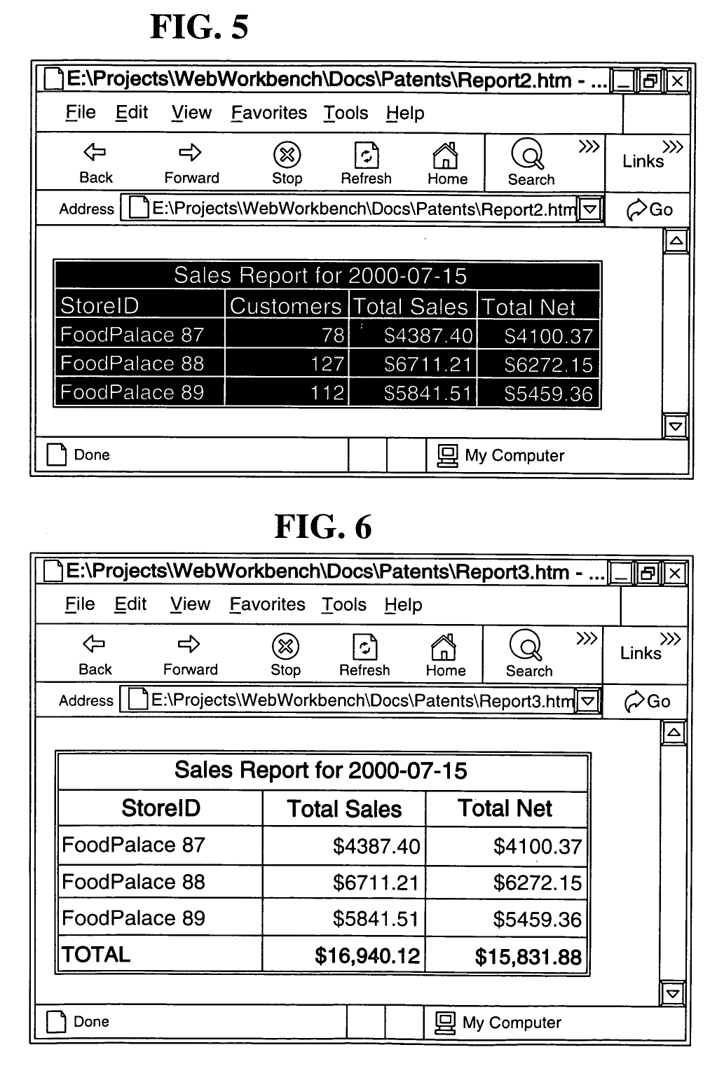

FIG. 5 shows the result of formatting the Listing 1 Sales Report using a second XSL definition. Specifically, the XSL definition changes the font, adds color, adds dollar signs to the currency values, and adjusts the field alignment.

Listing 4 shows the second XSL definition used to produce the Report of FIG. 5. Listing 5 shows the HTML source created by applying the Listing 4 XSL definition to the Listing 1 XML data. Listing 5, when viewed using a web browser, is interpreted and viewed as FIG. 5.

### Listing 4

<?xml version=“1.0” encoding=“UTF-8” ?>
<xsl:stylesheet xmlns:xsl=“http://www.w3.org/TR/WD-xsl”>
<xsl:template>

<xsl:apply-templates/>

</xsl:template>
<xsl:template match=“/”>

<HTML>
<BODY>
<STYLE>

TD.ReportHeader {BORDER-COLOR: #000000;BACKGROUND-COLOR:

#000080;COLOR: #ffcc00;FONT-FAMILY: verdana, arial, helvetica;FONT-SIZE:
12px;FONT-WEIGHT: bold}

TD.ReportData {BORDER-COLOR: #000000;BACKGROUND-COLOR:

#000080;COLOR: #ffffff;FONT-FAMILY: verdana, arial, helvetica;FONT-SIZE:
12px;FONT-WEIGHT: bold}

TD.ReportSummary {BORDER-COLOR: #000000;BACKGROUND-COLOR:

#000080;COLOR: #ffcc00;FONT-FAMILY: verdana, arial, helvetica;FONT-SIZE:
12px;FONT-WEIGHT: bold}

</STYLE>
<xsl:apply-templates select=“SalesReport”/>
</BODY>
</HTML>

</xsl:template>
<xsl:template match=“SalesReport”>

<TABLE cellspacing=“1” border=“1”>

<TR>

<TD class=“ReportHeader” ColSpan=“100%” Align=“Center”>Sales Report for

<xsl:value-of select=“@Date”/></TD>

</TR>
<TR>

<TD class=“ReportHeader”>StoreID</TD>
<TD class=“ReportHeader”>Customers</TD>
<TD class=“ReportHeader”>Total Sales</TD>
<TD class=“ReportHeader”>Total Net</TD>

</TR>
<xsl:for-each select=“Store”>
<TR>

<TD class=“ReportData”><xsl:value-of select=“StoreID”/></TD>
<TD class=“ReportData” Align=“Right”><xsl:value-of

select=“TotalCustomers”/></TD>

<TD class=“ReportData” Align=“Right”>$<xsl:value-of

select=“TotalSales”/></TD>

<TD class=“ReportData” Align=“Right”>$<xsl:value-of select=“TotalNet”/></TD>

</TR>
</xsl:for-each>

</TABLE><BR/>

</xsl:template>
</xsl:stylesheet>

### Listing 5

<HTML>

<BODY>

<STYLE>

| | |
|---|---|
| TD.ReportHeader | {BORDER-COLOR: #000000;BACKGROUND-COLOR: |

#000080;COLOR: #ffcc00;FONT-FAMILY: verdana, arial, helvetica;FONT-SIZE:
12px;FONT-WEIGHT: bold}

| | |
|---|---|
| TD.ReportData | {BORDER-COLOR: #000000;BACKGROUND-COLOR: |

#000080;COLOR: #ffffff;FONT-FAMILY: verdana, arial, helvetica;FONT-SIZE:
12px;FONT-WEIGHT: bold}

| | |
|---|---|
| TD.ReportSummary | {BORDER-COLOR: #000000;BACKGROUND-COLOR: |

#000080;COLOR: #ffcc00;FONT-FAMILY: verdana, arial, helvetica;FONT-SIZE:
12px;FONT-WEIGHT: bold}

</STYLE>
<TABLE cellspacing=“1” border=“1”>

<TR>

<TD class=“ReportHeader” ColSpan=“100%” Align=“Center”>

Sales Report for 2000-07-15

</TD>

</TR>
<TR>

<TD class=“ReportHeader”>StoreID</TD>
<TD class=“ReportHeader”>Customers</TD>
<TD class=“ReportHeader”>Total Sales</TD>
<TD class=“ReportHeader”>Total Net</TD>

</TR>
<TR>

<TD class=“ReportData”>FoodPalace 87</TD>
<ID class=“ReportData” Align=“Right” >78</TD>
<TD class=“ReportData” Align=“Right” >$4387.40</TD>
<TD class=“ReportData” Align=“Right” >$4100.37</TD>

</TR>
<TR>

<TD class=“ReportData”>FoodPalace 88</TD>
<TD class=“ReportData” Align=“Right” >127</TD>
<TD class=“ReportData” Align=“Right” >$6711.21</TD>
<TD class=“ReportData” Align=“Right” >$6272.15</TD>

</TR>
<TR>

<TD class=“ReportData”>FoodPalace 89</TD>
<TD class=“ReportData” Align=“Right” >112</TD>
<TD class=“ReportData” Align=“Right” >$5841.51</TD>
<TD class=“ReportData” Align=“Right” >$5459.36</TD>

</TR>

</TABLE>

</BODY>

</HTML>

FIG. 6 shows the result of formatting the Listing 1 Sales Report using a third XSL definition. In this case, the user added dollar signs and adjusted the field alignment, but removed the “Customers” information. In addition, a TOTAL field was added to show an overall financial summary. Note that the TOTAL information did not modify the original report content, it simply added to it.

Listing 6 shows the second XSL definition used to produce the Report of FIG. 6. Listing 7 shows the HTML source created by applying the Listing 6 XSL definition to the Listing 1 XML data. Listing 7, when viewed using a web browser, is interpreted and viewed as FIG. 6.

### Listing 6

<?xml version=“1.0” encoding=“UTF-8” ?>
<xsl:stylesheet xmlns:xsl=“http://www.w3.org/TR/WD-xsl”>
<xsl:template>

<xsl:apply-templates/>

</xsl:template>
<xsl:template match=“/”>

<HTML>
<BODY>
<xsl:apply-templates select=“SalesReport”/>
</BODY>
</HTML>

</xsl:template>
<xsl:template match=“SalesReport”>

<TABLE cellspacing=“1” border=“1”>

<TR>

<TD ColSpan=“100%” Align=“Center” Style=“font-weight:bold”>Sales Report for

<xsl:value-of select=“@Date”/></TD>

</TR>
<TR>

<TD Align=“Center” Style=“font-weight:bold”>StoreID</TD>
<TD Align=“Center” Style=“font-weight:bold”>Total Sales</TD>
<TD Align=“Center” Style=“font-weight:bold”Total Net</TD>

</TR>
<xsl:for-each select=“Store”>

<TR>

<TD Align=“Left”><xsl:value-of select=“StoreID”/></TD>
<TD Align=“Right”><xsl:apply-templates select=“TotalSales”/></TD>
<TD Align=“Right”><xsl:apply-templates select=“TotalNet”/></TD>

</TR>

</xsl:for-each>
<TR>

<TD Style=“font-weight:bold”> TOTAL </TD>
<TD Style=“font-weight:bold” align=“right”>

<xsl:eval>returntotalsales( )</xsl:eval></TD>

<TD Style=“font-weight:bold” align=“right”>

<xsl:eval>returntotalnet( )</xsl:eval></TD>

</TR>

</TABLE><BR/>

</xsl:template>
<xsl:template match=“TotalSales”>

<xsl:eval>totalsales(this)</xsl:eval>

</xsl:template>
<xsl:template match=“TotalNet”>

<xsl:eval>totalnet(this)</xsl:eval>

</xsl:template>
<xsl:script><![CDATA[

salestotal = 0;
nettotal = 0;
function totalsales(e) {

amount = parseFloat(e.text);
salestotal += amount;
return formatNumber(e.text, “$####.00”);

}
function returntotalsales( ) {

return formatNumber(salestotal, “$#,###.00”);

}
function totalnet(e) {

amount = parseFloat(e.text);
nettotal += amount;
return formatNumber(e.text, “$####.00”);

}
function returntotalnet( ) {

return formatNumber(nettotal, “$#,###.00”);

}

]]></xsl:script>
</xsl:stylesheet>

### Listing 7

<HTML>

<BODY>

<TABLE cellspacing=“1” border=“1”>

<TR>

<TD ColSpan=“100%” Align=“Center” Style=“font-weight:bold”>

Sales Report for 2000-07-15

</TD>

</TR>
<TR>

<TD Align=“Center” Style=“font-weight:bold”>StoreID</TD>
<TD Align=“Center” Style=“font-weight:bold”>Total Sales</TD>
<TD Align=“Center” Style=“font-weight:bold”>Total Net</TD>

</TR>
<TR>

<TD>FoodPalace 87</TD>
<TD Align=“Right”>$4387.40</TD>
<TD Align=“Right”>$4100.37</TD>

</TR>
<TR>

<TD>FoodPalace 88</TD>
<TD Align=“Right”>$6711.21</TD>
<TD Align=“Right”>$6272.15</TD>

</TR>
<TR>

<TD>FoodPalace 89</TD>
<TD Align=“Right”>$5841.51</TD>
<TD Align=“Right“>$5459.36</TD>

</TR>
<TR>

<TD Style=“font-weight:bold”>TOTAL</TD>
<TD Align=“Right” Style=“font-weight:bold”>$16,940.12</TD>
<TD Align=“Right” Style=“font-weight:bold”>$15,831.88</TD>

</TR>

</TABLE>

</BODY>

</HTML>

The XSL files used to generate the FIG. 5 and FIG. 6 reports could be created by a user to customize their view of the sales report without requiring expensive web site changes or interruptions to other users.

### Hardware Overview

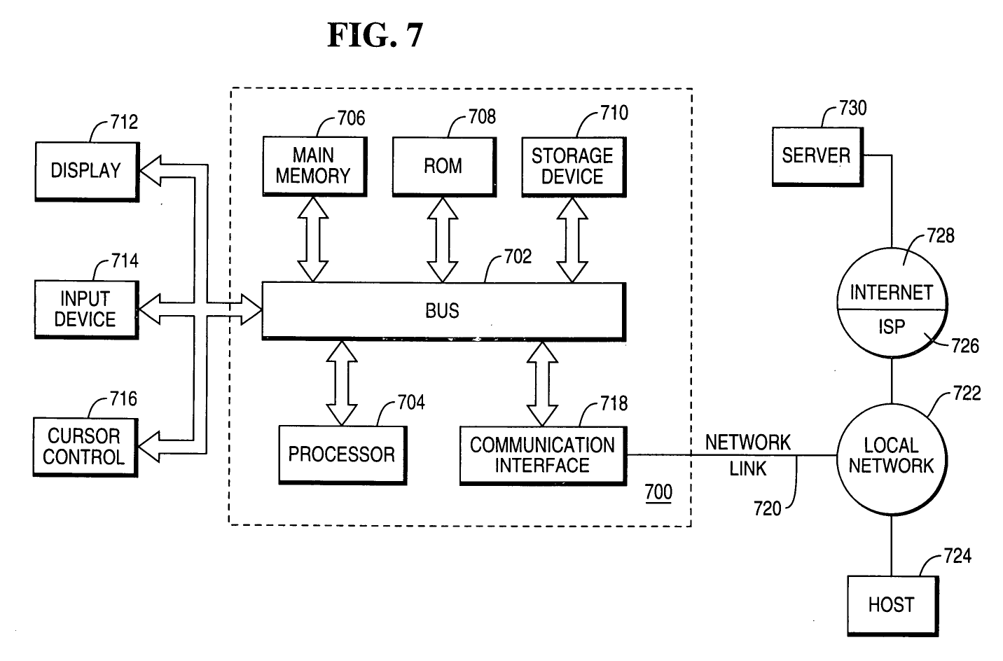

FIG. 7 is a block diagram illustrating an exemplary computer system 700 upon which an embodiment of the invention may be implemented. The present invention is usable with currently available personal computers, mini-mainframes and the like.

Computer system 700 includes a bus 702 or other communication mechanism for communicating information, and a processor 704 coupled with the bus 702 for processing information. Computer system 700 also includes a main memory 706, such as a random access memory (RAM) or other dynamic storage device, coupled to the bus 702 for storing transaction and interaction data, and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to the bus 702 for storing static information and instructions for the processor 704. A storage device 710, such as a magnetic disk or optical disk, is provided and coupled to the bus 702 for storing transaction and interaction data, inventory data, orders data, and instructions.

Computer system 700 may be coupled via the bus 702 to a display 712, such as a cathode ray tube (CRT) or a flat panel display, for displaying an HTML-based report to the user. An input device 714, including alphanumeric and function keys, is coupled to the bus 702 for communicating information and command selections to the processor 704. Another type of user input device is cursor control 716, such as a mouse, a trackball, or cursor direction keys for communicating direction information and command selections to processor 704 and for controlling cursor movement on the display 712. This input device typically has two degrees of freedom in two axes, a first axis (e.g., x) and a second axis (e.g., y) allowing the device to specify positions in a plane.

The invention is related to the use of computer system 700, such as the illustrated system of FIG. 7, to generate a report using XML and XSL. According to one embodiment of the invention, the report is generated by the computer system 700 in response to processor 704 executing sequences of instructions contained in main memory 706 in response to input received via input device 714, cursor control 716, or communication interface 718. In particular, computer system 700 receives XML-formatted report content and applies an XSL format, obtained from main memory 706 or storage device 710, to the report content to generate an HTML-based report. Such instructions may be read into main memory 706 from another computer-readable medium, such as storage device 710.

However, the computer-readable medium is not limited to devices such as storage device 710. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 706 causes the processor 704 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 700 also includes a communication interface 718 coupled to the bus 702. Communication interface 708 provides two-way data communication as is known. For example, communication interface 718 may be an integrated services digital network (ISDN) card, a digital subscriber line (DSL) card, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals which carry digital data streams representing various types of information. Of particular note, the communications through interface 718 may permit transmission or receipt of XML-based report content and the generated HTML-based report. For example, two or more computer systems 700 may be networked together in a conventional manner with each using the communication interface 718.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals which carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. In accordance with the invention, one such downloaded application provides for generating a report using XML and XSL.

The received code may be executed by processor 704 as it is received, and/or stored in storage device 710, or other non-volatile storage for later execution. In this manner, computer system 700 may obtain application code in the form of a carrier wave.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A computer-implemented method of generating a report using a markup language and stylesheet language comprising:
receiving report content in a markup language format; and
generating a markup language format report by applying a stylesheet language format to the received report content.

2. The method as claimed in claim 1, wherein the markup language format is XML-based.

3. The method as claimed in claim 1, wherein the stylesheet language format is XSL-based.

4. The method as claimed in claim 1, wherein the generated markup language format report is HTML-based.

5. The method as claimed in claim 1, wherein the received report content is received from a web site.

6. The method as claimed in claim 1, wherein the generated markup language format report is generated at a receiving computer.

7. The method as claimed in claim 1, wherein the received report content is received from a data store.

8. The method as claimed in claim 1, wherein the received report content is received by a web browser.

9. A method of generating a report using XML and XSL comprising:
receiving XML-based report content; and
generating an HTML-based format report by applying an XSL-based format to the XML-based report content.

10. A computer system for generating a web-based report using a markup language and a stylesheet language comprising:
one or more processors for receiving and transmitting data; and
a memory coupled to said one or more processors, said memory having stored therein a stylesheet language format and sequences of instructions which, when executed by one of said one or more processors, cause one of said one or more processors to receive report content in a markup language format, and generate a markup language format report by applying a stylesheet language format to the received report content.

11. The computer system as claimed in claim 10, wherein the markup language format is XML-based.

12. The computer system as claimed in claim 10, wherein the stylesheet language format is XSL-based.

13. The computer system as claimed in claim 10, wherein the generated markup language format report is HTML-based.

14. The computer system as claimed in claim 10, wherein the received report content is received from a web site.

15. The computer system as claimed in claim 10, wherein the generated markup language format report is generated at a receiving computer.

16. The computer system as claimed in claim 10, wherein the received report content is received from a data store.

17. The computer system as claimed in claim 10, wherein the received report content is received by a web browser.
